(19) United States
(12) Patent Application Publication
(10) Pub. No.: US 2009/0197690 A1
(43) Pub. Date: Aug. 6, 2009

(54) Damped Axle Shaft

(75) Inventor: Anthony L. Lyscio, Southfield, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 12/026,696

(22) Filed: Feb. 6, 2008

(51) Int. Cl. F16C 3/02

(52) U.S. Cl. 464/180

(57) ABSTRACT

An axle shaft which is inherently damped very near the source of the oscillation, via inner and outer axle components with a damping ring that couples between them, wherein the inner component which serves as the axle shaft, has a torsional stiffness different from (i.e., less than) that of the outer component which serves as a concentrically disposed axle sleeve. Under torsional load, both the inner and outer components transmit the torsional load, wherein the inner component twists more than the outer component, resulting in relative displacement therebetween. The damping ring experiences the relative displacement and consequently damps energy of the twist, whereby powerhop and associated driveline disturbances, such as for example axle shutter, are reduced.

### TECHNICAL FIELD

The present invention relates generally to drive axle shafts of motor vehicles, and more particularly to a damped axle shaft having inner and outer components which are mutually torsionally damped.

### BACKGROUND OF THE INVENTION

Motor vehicles with driven axle independent suspensions include a pair of axle shafts (also referred to as split axles or half shafts), one for each wheel, as described, merely by way of exemplification, in U.S. Pat. No. 4,699,235 issued on Oct. 13, 1987 to Anderson and assigned to the assignee of the present patent application, the disclosure of which is hereby incorporated herein by reference.

Referring now to FIG. 1, the split axle drive system of U.S. Pat. No. 4,699,235 will be briefly described for point of reference, it being understood the present invention may apply to two wheel drive or four wheel drive systems.

Shown is a schematic plan view of a part-time four-wheel drive vehicle, comprising an internal combustion engine 10, transmission 12 and transfer case 14 mounted on a vehicle chassis (not shown). The engine 10 and transmission 12 are well-known components as is the transfer case 14 which typically has an input shaft (not shown), a main output shaft 16 and an auxiliary output shaft 18. The main output shaft 16 is drive connected to the input shaft in the transfer case 14 and is customarily aligned with it. The auxiliary output shaft 18 is drive connectable to the input shaft by a clutch or the like in the transfer case 14 and customarily offset from it. The transfer case clutch is actuated by a suitable selector mechanism (not shown) which is generally remotely controlled by the vehicle driver.

The main output shaft 16 is drivingly connected to a rear propeller shaft 20 which in turn is drivingly connected to a rear differential 22. The rear differential 22 drives the rear wheels 24 through split axle parts in a well-known manner. The auxiliary output shaft 18 is drivingly connected to a front propeller shaft 26 which in turn is drivingly connected to a split axle drive mechanism 28 for selectively driving the front wheels 30 through split axle parts. The split axle drive mechanism 28 is attached to the vehicle chassis by means including a bracket 71 on an extension tube 66.

Suitable split axle parts, commonly referred to as half shafts, are well known from front wheel drive automobiles. These may be used for connecting the split axle drive mechanism 28 to the front wheels 30. The drawings schematically illustrate a common type of half shaft for driving connection to independently suspended steerable vehicle wheels comprising an axle shaft 76 having a plunging universal joint 78 at its inboard end adapted for connection to an output such as the flange 72 or 74 and the well-known Rzeppa-type universal joint 80 at its outboard end adapted to be connected to the vehicle wheel 30. Similar axle shaft configurations are also commonly employed in vehicles with driven rear axles and independent rear suspensions.

Problematically, axle shafts frequently exhibit “powerhop” when a large amount of torque is applied thereto. Powerhop typically occurs when tire friction with respect to a road surface is periodically exceeded by low frequency (i.e., below about 20 Hz) oscillations in torsional windup of the axle shafts. Powerhop produces oscillatory feedback to suspension and driveline components and can be felt by the vehicle occupants, who may describe the sensation as “bucking,” “banging,” “kicking” or “hopping.”

Axle shafts are typically manufactured from steel bar material and, as such, act as very efficient torsonal springs. In the interest of reducing unwanted oscillations in the axle shafts, the standard practice has been to adjust the size (i.e., increasing the diameter) of the axle shafts in order to tune the resonating frequencies in such a way to minimize the negative impact of oscillations by increasing the overall torsional stiffness of the axle shafts, thereby reducing powerhop. However, increasing the diameter of the axle shafts results in additional packaging, mass and cost related problems, while not really addressing the core issue of directly damping oscillations that are associated with powerhop, to with: lack of damping to absorb energy placed into the driveline by the negative damping characteristics of the tires during hard longitudinal acceleration or deceleration.

Accordingly, there is a clearly felt need in the art for axle shafts which are inherently damped very near the source of the oscillation, and thereby provide reduction of powerhop and associated driveline disturbances, such as for example axle shutter.

### SUMMARY OF THE INVENTION

The present invention is an axle shaft which is inherently damped very near the source of the oscillation, via inner and outer axle components with at least one damping ring that couples between them, wherein the inner component has a torsional stiffness different from that of the outer component. Under torsional load, both the inner and outer components transmit the torsional load, wherein the inner component twists more than the outer component, resulting in relative displacement therebetween. The at least one damping ring experiences the relative displacement and consequently damps energy from the system whereby reduced are powerhop and associated driveline disturbances, such as for example axle shutter.

In the preferred embodiment, the inner component is the axle shaft, itself, and the outer component is an axle tube concentrically disposed with respect to the axle shaft and generally co-terminal therewith (less any splines, etc.). Preferably, the inner component has a torsional stiffness less than that of the outer component such that under a torsional load carried by the inner and outer components, the inner component twists more than the outer component twists. The at least one damping ring is disposed so as to experience the angular displacement resulting from the differing twists of the inner and outer components and is preselected to provide a desired energy damping in response thereto.

In a first example of the preferred embodiment, one end of the axle tube is rigidly affixed to the axle shaft and the other end of the axle tube is open whereat a damping ring is disposed between the axle tube and the axle shaft. The damping ring has at least one sliding surface at which, respectively, the axle shaft or the axle tube slides in response to the angular displacement of the axle shaft with respect to the axle tube when a torsonal load is applied thereto, wherein energy dissipation by Coulomb friction occurs at the at least one sliding surface of the damping ring.

In a second example of the preferred embodiment, one end of the axle tube is rigidly affixed to the axle shaft, and the other end of the axle tube is open whereat a damping ring is disposed between the axle tube and the axle shaft. The damping ring, which is a high damping elastic (resilient) material, as for example a rubber, is affixed to the axle tube and the axle shaft, wherein torsional twist relatively between the axle shaft and the axle tube results in energy dissipation by elastic deformation of the damping ring.

In a third example of the preferred embodiment, each end of the axle tube is open and has disposed thereat a respective damping ring located between the axle tube and the axle shaft. Each damping ring, which is a high damping elastic (resilient) material, as for example a rubber, is affixed to the axle tube and the axle shaft, wherein torsional twist relatively between the axle shaft and the axle tube results in energy dissipation by elastic deformation of both of the damping rings.

Accordingly, it is an object of the present invention to provide an inherently damped very near the source of the oscillation, via inner and outer axle components with a damping ring that slidably couples them

This and additional objects, features and advantages of the present invention will become clearer from the following specification of a preferred embodiment.

### BRIEF DESCRIPTION OF THE DRAWINGS

FIG. 1 is a schematic plan view of a prior art motor vehicle having a split axle drive mechanism.

FIG. 2 is a partly sectional side view of a damped axle shaft in accordance with a first aspect of a first example of the present invention.

FIG. 2A is a cross-sectional view, seen along line 2A-2A of FIG. 2.

FIG. 2B is a cross-sectional view, seen along line 2B-2B of FIG. 2.

FIG. 2C is a view as in FIG. 2A, showing an example of the torsional twists in response to a torsional load in the counterclockwise direction.

FIG. 2D is a view as in FIG. 2A, showing an example of the torsional twists in response to a torsional load in the clockwise direction.

FIG. 3 is a partly sectional side view of a damped axle shaft in accordance with a second example of the present invention.

FIG. 3A is a cross-sectional view, seen along line 3A-3A of FIG. 3.

FIG. 3B is a cross-sectional view, seen along line 3B-3B of FIG. 3.

FIG. 3C is a view as in FIG. 3A, showing an example of the torsional twists in response to a torsional load in the counterclockwise direction.

FIG. 3D is a view as in FIG. 3A, showing an example of the torsional twists in response to a torsional load in the clockwise direction.

FIG. 4 is a partly sectional side view of a damped axle shaft in accordance with a third example of the present invention.

FIG. 4A is a cross-sectional view, seen along line 4A-4A of FIG. 4.

FIG. 4B is a cross-sectional view, seen along line 4B-4B of FIG. 4.

FIG. 4C is a view as in FIG. 4A, showing an example of the torsional twists in response to a torsional load in the counterclockwise direction.

FIG. 4D is a view as in FIG. 4B, showing an example of the torsional twists in response to a torsional load in the counterclockwise direction.

FIG. 4E is a view as in FIG. 4A, showing an example of the torsional twists in response to a torsional load in the clockwise direction.

FIG. 4F is a view as in FIG. 4B, showing an example of the torsional twists in response to a torsional load in the clockwise direction.

FIG. 5 is a schematic representation of a motor vehicle rear suspension incorporating a pair of damped axle shafts according to the present invention.

### DESCRIPTION OF THE PREFERRED EMBODIMENT

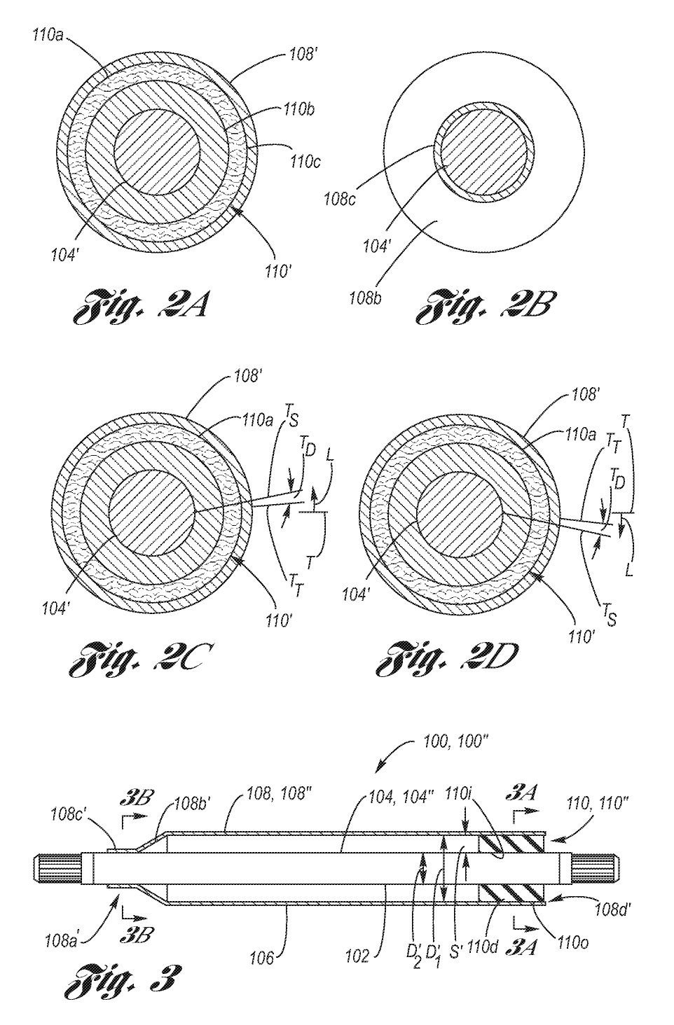

Referring now to the Drawing, FIGS. 2 through 5 depict various examples of a damped axle shaft 100 according to the present invention, wherein throughout the views, the damped axle shaft 100 is inherently damped very near the source of the oscillation, which in the case of powerhop, the source is generally the torsional wind-up of the axle shaft vis-à-vis the attendant response of the tires meeting the road surface.

The damped axle shaft 100 includes, generally, an inner axle component 102 which serves as the axle shaft 104 having a first torsional stiffness, an outer axle component 106 in the form of a cylindrical axle tube 108 which is concentrically disposed with respect to the axle shaft and generally co-terminal therewith (by the term generally co-terminal is meant generally co-terminal not inclusive of the splines, or other rotative drive interface, at each end of the axle shaft) and has a second torsional stiffness, and at least one damping ring 110 disposed between the axle shaft and the axle tube.

Both the axle shaft 104 and the axle tube 108 transmit an applied torsional load, and in response thereto the axle shaft, per its selected first torsional stiffness twists differently from the axle tube, per its selected second torsional stiffness. The resulting relative displacement therebetween is experienced by the at least one damping ring, whereby a desired energy damping in response to the difference in twisting of the axle shaft with respect to the axle tube.

In this regard, it is sufficient that the structural configuration of the damped axle shaft 100 be such that under torsional load, the axle shaft 104 twists differently with respect to the axle tube 108, resulting in relative angular displacement therebetween, wherein the at least one damping ring experiences the relative angular displacement of the axle shaft with respect to the axle tube and consequently damps energy associated with the twisting due to the torsional load, whereby powerhop and associated driveline disturbances, such as for example axle shutter are reduced.

A first example of the preferred embodiment of the damped axle 100′ is depicted at FIGS. 2 through 2D.

At FIG. 2, the axle tube 108′ is connected by rigid affixment to the axle shaft 104′ at an affixment end 108a, as for example via a reduced diameter portion 108b terminating at a sleeve 108c. The affixment end 108a is affixed to the axle shaft 104′, as for example by welding, crimping, press-fitting or other connection modality, of the sleeve 108c to the axle shaft. At the affixment end 108a, the axle shaft and the axle tube are constrained to rotate in unison. The axle tube 108′ has an inside diameter D₁ which is greater than the outer diameter D₂ of the axle shaft 104′, whereby the axle tube is spaced from the axle shaft a distance S. The axle tube has an open end 108d opposite the affixment end 108a.

At the open end 108d is located the damping ring 110′, which is affixed to either the axle tube or the axle shaft and may has a sliding surface 110a opposite the affixment. By way of example, the affixment is via a metallic sleeve 110b attached to the axle shaft, as for example by a press-fit, so that it must rotate in unison with the axle shaft without slipping, and a frictional annulus 110c, composed of a durable frictional material, as for example a brake pad or clutch lining type of frictional material, which is circumferentially disposed without slippage upon the sleeve.

In operation, as seen at FIGS. 2C and 2D, a torsional load L applied clockwise or counterclockwise results in a twist from T to T_{S} of the axle shaft 104′ which is greater than the twist from T to T_{T} of the axle tube 108′, there being an angular displacement T_{D} therebetween. Since the sleeve 110′ must rotate in unison with the axle shaft 104′, the angular displacement T_{D} is registered at the sliding surface 110a by which the sliding surface slides frictionally with respect to an inner surface 108s of the axle tube. This frictional sliding provides energy damping, and consequently, oscillation damping which mitigates powerhop and associated undesirable oscillatory effects.

By way of preferred example, the frictional sliding provides damping due to Coulomb friction, which is a widely known physical process involving relative movement between contacting surfaces. In the Coulomb friction as it is believed to operate with respect to the example depicted at FIG. 2, damping of modal excitations is provided at an interfacial boundary 112 formed between the sliding surface 110a of the damping ring 110′ and the inner surface 108s of the axle tube 108′, wherein the material of the axle tube 108′ may be, for example, steel. The Coulomb friction represents the energy absorption processes at the interfacial boundary 112 through mechanical surface-to-surface interaction processes. It will be understood that the materials can be other than that depicted and described, including metal on metal, and including sliding of the damping ring with respect to either or both of the axle shaft and the axle tube.

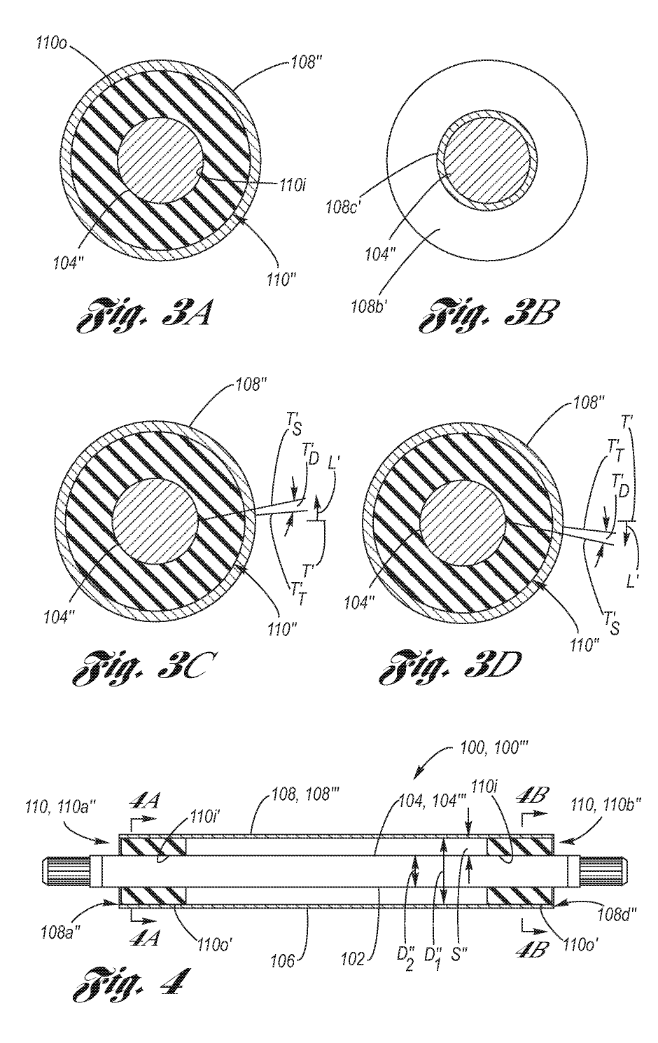

Turning attention now to FIGS. 3 through 3D, a second example of the preferred embodiment of the damped axle 100″ is depicted.

At FIG. 3, the axle tube 108″ is connected by rigid affixment to the axle shaft 104″ at an affixment end 108a′, as for example via a reduced diameter portion 108b′ terminating at a sleeve 108c′. The affixment end 108a′ is affixed to the axle shaft 104″, as for example by welding, crimping, press-fitting or other connection modality, of the sleeve 108c′ to the axle shaft. At the affixment end 108a′, the axle shaft and the axle tube are constrained to rotate in unison. The axle tube 108″ has an inside diameter D₁′ which is greater than the outer diameter D₂′ of the axle shaft 104″, whereby the axle tube is spaced from the axle shaft a distance S′. The axle tube has an open end 108d′ opposite the affixment end 108a′.

At the open end 108d′ is located the damping ring 110″, which is affixed to both the axle tube 104″ and the axle shaft 108″, there being no sliding surface. By way of example, the affixments are via an adhesive or other bonding modality so that the inner surface 110i must rotate in unison with the axle shaft 104″ without slipping and the outer surface 110o must rotate in unison with the axle tube 108″ without slipping. The material of the damping ring is preferably homogeneous and composed of, for example, a high damping elastic (resilient) material, most preferably a high damping rubber.

In operation, as seen at FIGS. 3C and 3D, a torsional load L′ applied clockwise or counterclockwise results in a twist from T′ to T_{S}′ of the axle shaft 104″ which is greater than the twist from T′ to T_{T}′ of the axle tube 108″, there being an angular displacement T_{D}′ therebetween. Since the damping ring 110″ must rotate in unison at its connections to each of the axle shaft 104″ at the inner surface 110i and the axle tube 108″ at the outer surface 110o, the angular displacement T_{D}′ is registered by the damping ring 110″ as an internal elastic deformation equal to the angular displacement T_{D}′. This internal elastic deformation provides energy damping, and consequently, oscillation damping which mitigates powerhop and associated undesirable oscillatory effects.

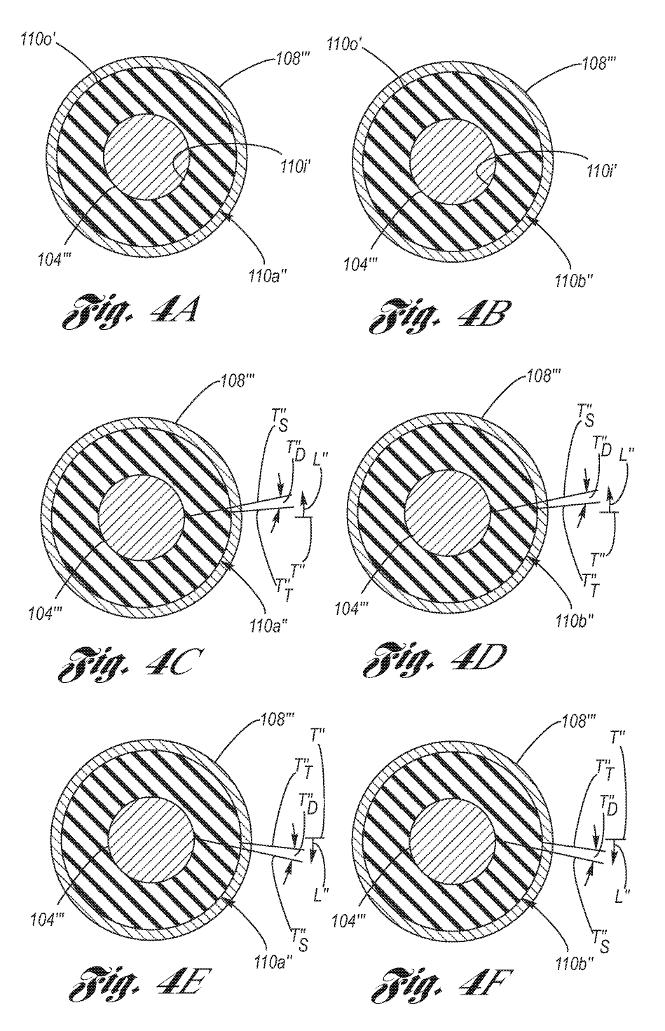

Turning attention now to FIGS. 4 through 4F, a third example of the preferred embodiment of the damped axle 100′″ is depicted.

At FIG. 4, the axle tube 108′″ is not rigidly affixed to the axle shaft 104″, being open at both ends 108a″ and 108b″. The axle tube 108′″ has an inside diameter D₁″ which is greater than the outer diameter D₂″ of the axle shaft 104″, whereby the axle tube is spaced from the axle shaft a distance S″. At each open end 108a″, 108d″ is located respective first and second damping ring 110a″, 110b″ which are affixed to both the axle tube 104′″ and the axle shaft 108′″, there being no sliding surface. By way of example, the affixments are via an adhesive or other bonding modality so that the inner surface 110i′ of each of the first and second damping rings must rotate in unison with the axle shaft 104′″ without slipping and the outer surface 110o′″ of each of the first and second damping rings must rotate in unison with the axle tube 108′″ without slipping. The material of each of the first and second damping rings is preferably homogeneous and composed of, for example, a high damping elastic (resilient) material, most preferably a high damping rubber.

In operation, as seen at FIGS. 4C through 4F, a torsional load L″ applied clockwise or counterclockwise results in a twist T_{S}″ of the axle shaft 104′″ which is greater than the twist T_{T}″ of the axle tube 108′″, there being an angular displacement T_{D}″ therebetween. Since the first and second damping rings 110a″, 110b″ must each rotate in unison at its respective connections to the axle shaft 104′″ at the respective inner surfaces 101′ and the axle tube 108′″ at the respective outer surfaces 100o′, the angular displacement T_{D}″ is registered by each damping ring as an internal elastic deformation generally equal to the angular displacement T_{D}″ (the first and second damping rings may have mutually differing angular displacements). This internal elastic deformation provides energy damping, and consequently, oscillation damping which mitigates powerhop and associated undesirable oscillatory effects.

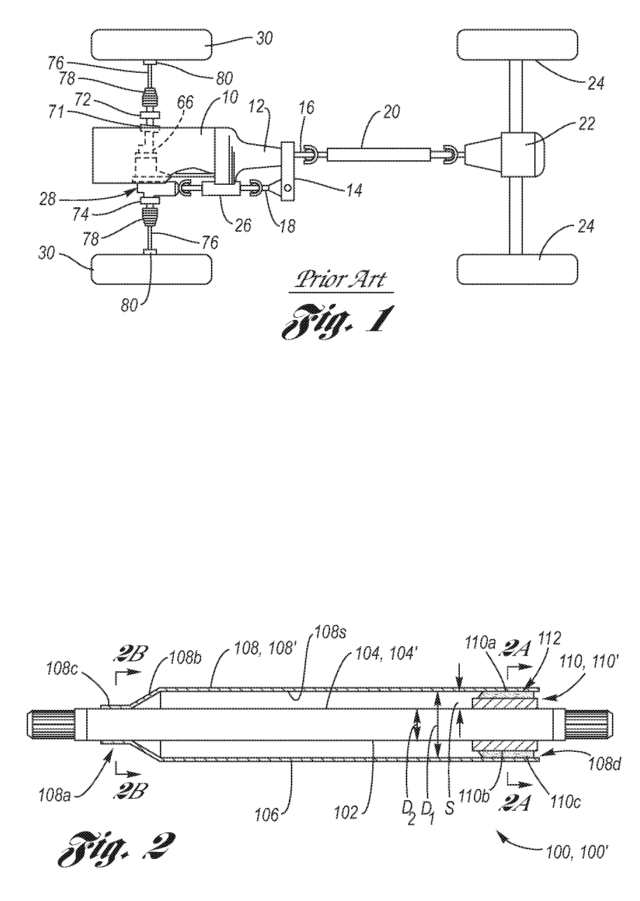

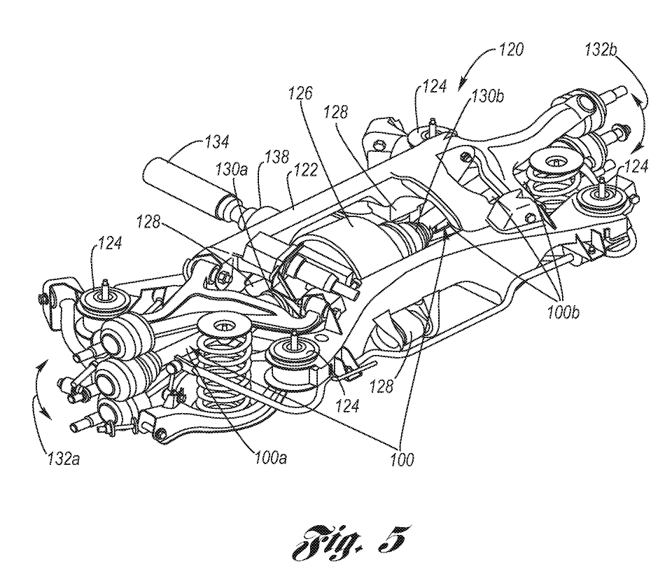

Turning attention now to FIG. 5, a non-limiting example of an environment of use of the damped axle shaft according to the present invention is depicted with respect to a motor vehicle rear suspension 120 which incorporates a set of damped axle shafts 100 according to the present invention: a first damped axle shaft 100a and a second damped axle shaft 100b (both as for example being configured for example per any of the configurations of FIG. 2, 3 or 4). The rear suspension 120 includes a cradle 122 which is attached by resilient cradle mounts 124 to a frame (not shown) of the motor vehicle. A rear differential module 126 is connected to the cradle 122 via resilient rear differential module mounts 128, and is further connected, via constant velocity joints 130a, 130b to the first and second axles shafts 100a, 100b. The first and second axle shafts 100a, 100b are independently suspended via the constant velocity joints 130a, 130b so they are able to independently articulate along arrows 132a, 132b. A propeller shaft 134 is connected at one end to a transmission (not shown) and at its other end, via a universal joint 138, to the rear differential module. It will be understood that the drive source to which the damped axle shafts 100 are drivingly connected may be other than a rear differential module, as for example the split axle drive mechanism of FIG. 1.

By way merely of an exemplification, the following particulars are provided. The axle shaft material is predominantly steel (mild or high strength), and may be an alloy. The axle shaft may have a length ranging from about 300 mm to about 600 mm, and have a diameter ranging from about 20 mm up to about 30 mm, tunable per application. The axle tube diameter may range from about 26 mm to about 60 mm, and have a wall thickness from about 2 mm to about 10 mm, tunable per application.

It should be noted that the location of the damping ring in the case of FIGS. 2 and 3 is preferably adjacent the wheel (i.e., the outboard side of the axle shaft), but may be otherwise. Further, the damping rings in the case of FIG. 4 may be of the same high damping elastic materials (the damping rings being symmetric) or may be of different high damping elastic materials (the damping rings being asymmetric).

To those skilled in the art to which this invention appertains, the above described preferred embodiment may be subject to change or modification. Such change or modification can be carried out without departing from the scope of the invention, which is intended to be limited only by the scope of the appended claims.

1. A damped axle shaft comprising:
an inner axle component having a first torsional stiffness;
an outer axle component concentrically disposed with respect to, and spaced from, said inner axle component, said outer axle component having a second torsional stiffness; and
at least one damping ring disposed between said first and second axle components;
wherein in response to a torsional load applied to said inner and outer axle components, said inner and outer axle components twist differently such that a resulting angular displacement therebetween is registered at said at least one damping ring such that said at least one damping ring damps energy associated with the twisting due to the torsional load.

2. The damped axle shaft of claim 1, wherein said inner axle component comprises an axle shaft; and wherein said outer axle component comprises an axle tube generally co-terminal with respect to said axle shaft.

3. The damped axle shaft of claim 1, wherein said first stiffness is less than said second stiffness, wherein said inner axle component twists more than said outer axle component in response to the torsional load.

4. The damped axle shaft of claim 3, wherein said inner axle component comprises an axle shaft; and wherein said outer axle component comprises an axle tube.

5. The damped axle shaft of claim 4, wherein one end of said axle tube is connected to said axle shaft such that thereat said axle tube must rotate in unison with said axle shaft; and wherein the other end of said axle tube is open and whereat is generally disposed said at least one damping ring.

6. The damped axle shaft of claim 5, wherein said at least one damping ring comprises at least one sliding surface which slides in relation to at least one of said axle shaft and said axle tube in response to the twisting.

7. The damped axle shaft of claim 6, wherein said sliding comprises a Coulomb friction process.

8. The damped axle shaft of claim 7, wherein said at least one damping ring is affixed to said axle shaft such that said at least one damping ring must rotate in unison with said axle shaft, wherein said sliding occurs with respect to said axle tube; and wherein said axle tube is generally co-terminal with respect to said axle shaft.

9. The damped axle shaft of claim 8, wherein said at least one damping ring comprises a sleeve affixed to said axle shaft and an annulus of frictional material attached sliplessly to said sleeve.

10. The damped axle shaft of claim 5, wherein said at least one damping ring comprises an elastic material affixed sliplessly to each of said axle shaft and said axle tube.

11. The damped axle shaft of claim 10, wherein said elastic material is a high damping rubber; and wherein said axle tube is generally co-terminal with respect to said axle shaft.

12. The damped axle shaft of claim 4, wherein each end of said axle tube is open; and wherein said at least one damping ring comprises:
a first damping ring generally disposed at one open end of said axle tube; and
a second damping ring generally disposed at the other open end of the axle tube.

13. The damped axle shaft of claim 12, wherein the first and second damping rings each comprise an elastic material affixed sliplessly to each of said axle shaft and said axle tube.

14. The damped axle shaft of claim 10, wherein said elastic material is a high damping rubber; and wherein said axle tube is generally co-terminal with respect to said axle shaft.

15. A drive system of a motor vehicle, comprising:
a drive source; and
a pair of damped axle shafts drivingly connected to the drive source; each damped axle shaft of said pair of damped axle shafts comprising:
an inner axle component having a first torsional stiffness;
an outer axle component concentrically disposed with respect to, and spaced from, said inner axle component, said outer axle component having a second torsional stiffness; and
at least one damping ring disposed between said first and second axle components;
wherein in response to a torsional load applied to said inner and outer axle components, said inner and outer axle components twist differently such that a resulting angular displacement therebetween is registered at said at least one damping ring such that said at least one damping ring damps energy associated with the twisting due to the torsional load.

16. The drive system of claim 15, wherein said inner axle component comprises an axle shaft; and wherein said outer axle component comprises an axle tube generally co-terminal with respect to said axle shaft.

17. The drive system of claim 16, wherein said first stiffness is less than said second stiffness, wherein said inner axle component twists more than said outer axle component in response to the torsional load.

18. The drive system of claim 17, wherein one end of said axle tube is connected to said axle shaft such that thereat said axle tube must rotate in unison with said axle shaft; and wherein the other end of said axle tube is open and whereat is generally disposed said at least one damping ring.

19. The drive system of claim 17, wherein each end of said axle tube is open; and wherein said at least one damping ring comprises:
a first damping ring generally disposed at one open end of said axle tube; and
a second damping ring generally disposed at the other open end of the axle tube.
